(19) United States
(12) Patent Application Publication
(10) Pub. No.: US 2006/0195359 A1
(43) Pub. Date: Aug. 31, 2006

(54) Combined rewards system and process

(76) Inventors: Nancy J. Robinson, Clayton, CA (US); Cathleen Lee Wilkins, Orinda, CA (US); Dorothy Scocci, San Ramon, CA (US)

Correspondence Address: GLENN PATENT GROUP, 3475 EDISON WAY, SUITE L, MENLO PARK, CA, 94025, US

(21) Appl. No.: 11/361,113

(22) Filed: Feb. 24, 2006

Related U.S. Application Data
(60) Provisional application No. 60/657,476, filed on Feb. 28, 2005.

(51) Int. Cl. G06Q 30/00

(52) U.S. Cl. 705/14

(57) ABSTRACT

A system and process that awards rewards currency, e.g. cash back rebate or rewards points, for credit card and check card purchases and that provides rewards for a customer's enterprise relationship is provided. Further provided is a methodology for enrollment into the combined rewards program or the relationship rewards program. Further provided is a methodology to show total combined points or cash earned where the points or amount of cash earned are parsed into the various accounts and purchases. Further provided is a methodology to communicate the currency earned by providing customers with periodic statements and newsletters, data online, and data through customer service representatives. Further provided is a mechanism by which to systematically enroll eligible products or services as defined by the enterprise, e.g. where the eligibility may be based on social security numbers or other unique customer numbers.

### CROSS-REFERENCE TO RELATED APPLICATIONS

This application claims priority to U.S. Provisional Patent Application Ser. No. 60/657,476, filed on Feb. 28, 2005, Attorney Docket Number WELL0054PR, which application is incorporated herein in its entirety by this reference thereto.

### BACKGROUND OF THE INVENTION

1. Technical Field

The invention relates to a system and method for an enterprise to know its customer and award the customer based on aspects of the customer's activities and relationship with the enterprise. More particularly, the invention relates to a system and process for an enterprise to award customers with rewards currency, such as points, cash rebate, etc., for certain customer activity, products, and/or services related to an enterprise.

2. Description of the Prior Art

Many individuals hold credit cards and check cards. At the same time, some enterprise credit card and check card programs offer a reward-based program as incentive for a target cardholder to use the card associated with the program. An individual often carries different cards to participate in a variety of different reward programs. A typical reward program awards points based upon the amount and/or type of purchases made with the card. Thus, depending on the purchase, an individual may select the card with the greatest reward opportunity associated with that particular purchase.

Banco Popular of Popular, Inc., provides a rewards program called Premia® under personal banking, a description of which is provided on the Banco Popular web site. Banco Popular mentions customers can receive points for certain activities but a deposit account or a credit card account with Banco Popular is required. For communicating earned rewards points to its customers, Banco Popular only offers issued statements on a quarterly basis

One issuer, Marshall & Ilsley Corporation (M&I Bank), has a combined rewards program that awards points for credit and check card spending. However, there are disadvantages of this program, as follows:
The credit card statement shows points earned on the credit card and the checking statement shows points earned on the check card. The showing of points earned is not combined into one statement.
A customer can view a combined points statement online and can call customer service for the same information. However, the rewards points are not parsed and displayed by credit card and check card.
The two cards combined have to share the same primary social security number.

To date, there is no program that offers a combined cash rewards or a relationship rewards program.

It would be advantageous to provide a customer with one consolidated statement showing the total combined rewards earned wherein the data are broken down by, i.e. parsed into, rewards currency (cash, points, etc.) earned from the various enterprise accounts, such as credit card and check card accounts. Also, it would be advantageous to allow a customer to see how he or she is earning rewards currency on a frequent basis.

It would further be advantageous to provide a customer with the total combined rewards currency earned via a variety of channels, such as periodic statements, the Internet online, and the enterprise's customer service representatives.

It would further be advantageous to provide one enrollment entry point for a customer through which any of the customer's enterprise accounts can be enrolled.

It would further be advantageous to systematically enroll products or services such as check cards, credit cards, loans, mortgages, etc., where eligibility is defined by the enterprise.

### SUMMARY OF THE INVENTION

A system and process that awards rewards currency, e.g. cash back rebate or rewards points, for credit card and check card purchases and that provides rewards for a customer's enterprise relationship is provided. Further provided is a methodology for enrollment into the combined rewards program or the relationship rewards program. Further provided is a methodology to show total combined points or cash earned where the points or amount of cash earned are parsed into the various accounts and purchases. Further provided is a methodology to communicate the currency earned by providing customers with periodic statements and newsletters, data online, and data through customer service representatives. Further provided is a mechanism by which to systematically enroll eligible products or services as defined by the enterprise, e.g. where the eligibility may be based on social security numbers or other unique customer numbers.

### BRIEF DESCRIPTION OF THE DRAWINGS

FIG. 1 is a flow diagram of a combined relationship rewards method according to the invention;

FIG. 2 is a flow diagram of combined cash back rewards method according to the invention;

FIG. 3 is a schematic diagram of a system architecture according to the invention;

FIG. 4 is a flow diagram of an embodiment of the combined rewards process according to the invention; and

FIG. 5 is a flow diagram of an embodiment of the relationship rewards process according to the invention.

### DETAILED DESCRIPTION OF THE INVENTION

A system and process that awards rewards currency, e.g. cash back rebate or rewards points, for credit card and check card purchases and that provides rewards for a customer's enterprise relationship is provided. Further provided is a methodology for enrollment into the combined rewards program or the relationship rewards program. Further provided is a methodology to show total combined points or cash earned where the points or amount of cash earned are parsed into the various accounts and purchases. Further provided is a methodology to communicate the currency earned by providing customers with periodic statements and newsletters, data online, and data through customer service representatives. Further provided is a mechanism by which to systematically enroll eligible products or services as defined by the enterprise, e.g. where the eligibility may be based on social security numbers or other unique customer numbers.

Acquisition and Usage

One embodiment of the invention provides a unique rewards program where customers can earn points for acquisition, balances, and usage of multiple products and services. One example application is a financial institution with products including credit cards, direct deposit accounts (DDA), check cards, mortgages, investments, home equity, etc. This concept can be applied to any industry, such as for example insurance or health, where the customer can own multiple products. However, describing the invention herein in terms of the financial institution and the products listed hereinabove are by way of example only and are not meant to be limiting. In one embodiment of the invention, a financial institution has an internal system of record (SOR) that contains the information about what products a customer owns and uses and the corresponding activity. Rewards currency is assigned to each product and activity. For example, one point is assigned for every $1 of credit card spend and one point is assigned for every $100 in a mortgage balance. The financial institution houses this point information and can provide a total amount as well as an itemized list of amount of points. Thus, points earned on all products are combined into one program and are redeemable for a wide variety of rewards choices ranging from travel to retail to cash redemption options. The invention enables a customer to view points frequently, parsed by product, e.g. split out by credit card and check card, via a monthly credit card statement and online. Hence, the invention allows an enterprise to know its customer and award the customer for the customer's entire relationship with the enterprise.

Unique Customer Number

In one embodiment of the invention, a unique customer number is used to identify and link together products owned by a customer, thereby enabling the awarding of rewards currency, e.g. points and cash back, based on customer ownership and usage of multiple products.

Systematic Enrollment

One embodiment of the invention targets and fulfills enrollment by identifying eligible cardholders with other products or services, such as check cards for example, identifying the corresponding account numbers, and systematically enrolling such card holder and account numbers. For example, the process may start with identifying the credit cardholder, identifying any check cards owned by either the primary or secondary credit cardholder, and systematically enrolling the check card accounts found. The enrollment process is then configured so that the check card points are combined with the credit card points. Thus, by providing a mechanism that systematically enrolls multiple check card accounts belonging to either the primary or secondary credit cardholder, the customer greatly benefits due to such an escalated process for earning points.

One embodiment of the invention offers a combined cash back rebate for product purchases, such as credit card and/or check card purchases, where the total combined spend from all cards are included. The amount of rebate earned can be determined by the enterprise. For example, in one embodiment of the invention, the enterprise determines the amount of rebate based on a monthly tiering process. For example, wherein the first $100 earns 0.50%, the next $200 earns 0.75% and any additional spend earns 1% for that month. A different rebate amount is applied based on amount spent per month, and is reset each month, not on an annual basis. The rebate can also be earned for ownership and/or for usage of additional bank products.

One embodiment of the invention offers combined points for purchases and the like. As an example, the enterprise can offer enrollees a reward program whereby one (1) point is earned per credit card dollar spent, such as per $1.00 credit card spent, and one (1) point is earned per offline check card spent, such as per $4.00 offline check card spent. Also, different schemes can be offered to different target customers. By way of example, one particular program can be offered to students, secured accounts, and low-line unsecured accounts and can be offered for a reduced annual program fee. Points are combined and eligible for a variety of redemption options.

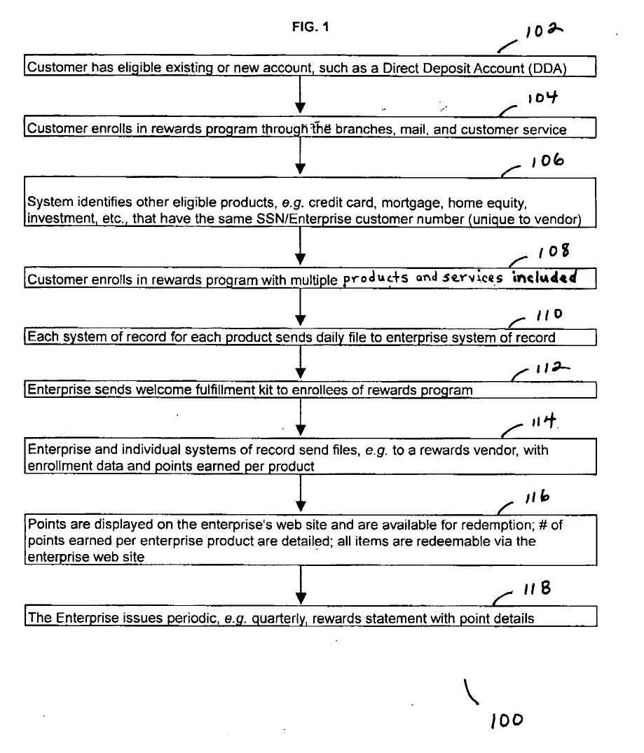

One embodiment of the invention can be described with respect to FIG. 1, a flow diagram of a combined relationship rewards method according to the invention (100). A customer has an eligible existing or new account, such as a Direct Deposit Account (102). The customer enrolls in the rewards program through entities such as for example branches, mail, and customer service (104). Then the system identifies other eligible products, e.g. credit card, mortgage, home equity, investment, etc., that have the same primary key, such as the customer's social security number (SSN) or the customer's enterprise customer number, which is unique to the enterprise (106), etc.

One Enrollment

Then, the system, having identified each eligible product, enrolls the customer in the rewards program with multiple products or services included (108). As part of ongoing processing, each system of record for each product sends a periodic, e.g. daily, file feed to the enterprise system of record (110). The system tracks the points earned per product and combines the points for a total amount. Such information is fed to various other internal or external, e.g. FDR and rewards vendor systems, such that customers can be provided with a points summary which provides details on how the points were earned by product.

In one embodiment of the invention, after the enrollment is completed, the enterprise sends a welcome fulfillment kit to enrollees of the rewards program (112), confirming enrollment and outlining benefits of the program. The enterprise and individual systems of record send files with enrollment data and points earned per product for processing, e.g. to a rewards vendor so the customer can view activity and points earned per product.

In one embodiment of the invention, two daily files are sent to the vendor. One file contains customer information such as name and address, in case there are any changes and the other file contains the number of points earned (114). The points earned and total points processed are displayed and are available for redemption on the enterprise's web site, on a statement, and via a customer service representative. The number of points earned per enterprise product is detailed (116). In one embodiment of the invention, all items are redeemable via the enterprise web site. The enterprise issues a periodic, e.g. quarterly rewards statement with point details (118).

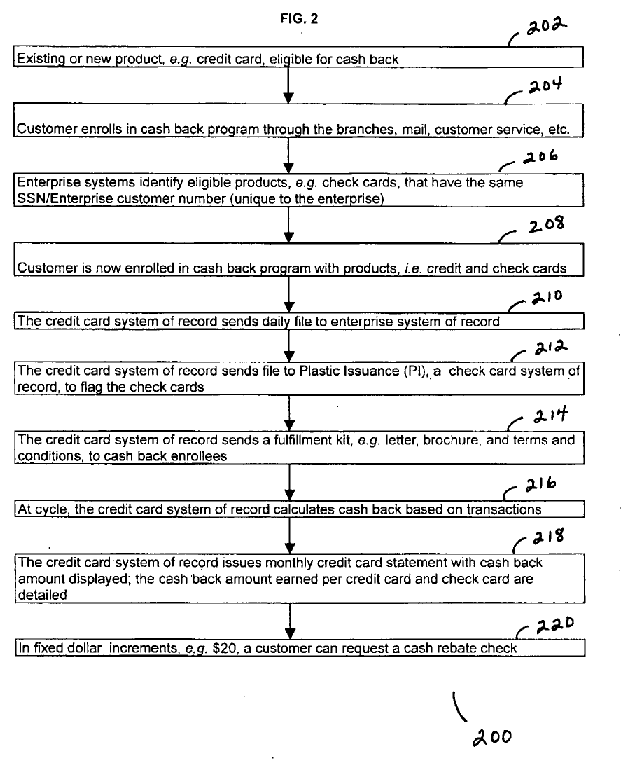

An alternate embodiment of the invention can be described with respect to FIG. 2, a flow diagram of a combined cash back rewards method according to the invention (200). An existing or new product, e.g. credit card, is eligible for cash back (202). The customer enrolls in the cash back program through mechanisms such as for example online, branches, mail, and customer service (204). The enterprise system identifies other eligible products, e.g. check cards that have the same SSN and/or an enterprise customer number, which is unique to the enterprise (206). The customer is systematically enrolled in the cash back program with products, e.g. credit and check cards (208). For ongoing processing, the credit card system of record sends a periodic, e.g. daily, file feed to the enterprise system of record (210). The credit card system of record sends a second file feed to a check card system of record to flag the check cards that are part of the combined enrollment for earning points (212). After the enrollment process, the credit card system of record sends a fulfillment kit containing, for example, letters, brochures, and terms and conditions, to cash back enrollees (214). In one embodiment of the invention, the credit card SOR performs such functionality, however this is by way of example only and is not meant to be limited to the credit card SOR. The credit card system of record calculates a cash back amount based on the customer's transactions (216). The credit card system of record issues a credit card statement, such as monthly, with the cash back amount displayed. The cash back amounts earned per credit card and the cash back amounts earner per check card are shown individually (218). In one embodiment of the invention, the customer can request a cash back rebate check or statement credit. In another embodiment of the invention, the amount of rebate is in fixed dollar increments, such as in $20.00 increments (220).

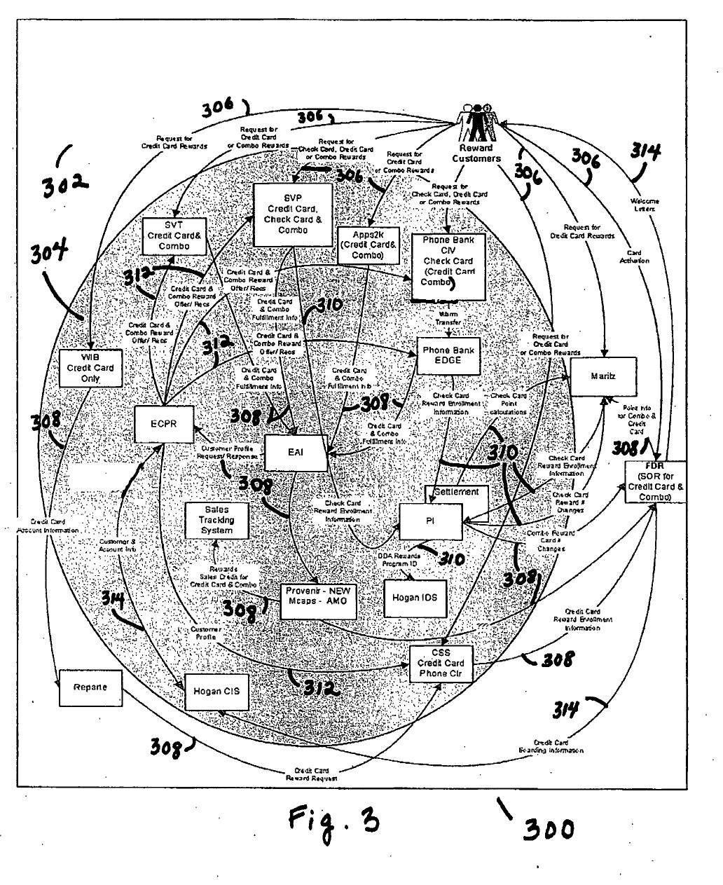

One embodiment of the invention can be described with reference to FIG. 3, a schematic diagram of a system architecture of the combined rewards program 300. FIG. 3 shows the various internal systems of an exemplary financial institution 304 and example systems outside the institution 302. Reward customers (client servers or by phone and the like) make requests for enrolling into the combined rewards program 306. The enrollment requests 306 have several entry points inside and outside the enterprise. The enrollment process includes checking other system SORs both internal and external for other accounts and/or products used and owned by the customer. The checking is performed using a proprietary and unique number, such as a social security number or unique enterprise customer number. In response to the enrollment requests, some internal and external systems perform fulfillment activities 308. In this example, credit card SORs perform combined rewards fulfillment 308. Also, in response to the enrollment requests, some internal and external systems or vendors perform fulfillment activities from check card SORs 310. An internal system, ECPR in this example, provides rewards recommendation and offers based on a customer's profile 312. Depending on the channel of enrollment, such as online, branches, and mail, etc., the enrollment may be fulfilled and processed by different internal systems, e.g. Provenir, Reparte, and EAI, etc. Also, systems may vary depending on which products or services are included. In this example, ECPR stands for Enterprise Customer Profiling and Referral and is a database of customer information or profiles. It can also be referred to as an offers database. Other system activity is carried out in parallel 314.

An Example Combined Rewards Implementation

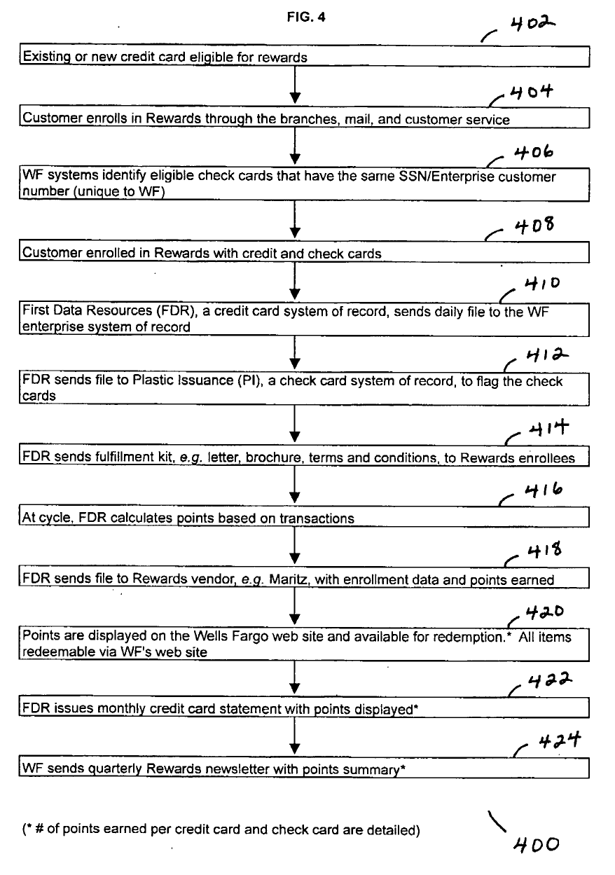

An example implementation by Wells Fargo can be described with reference to FIG. 4, a flow diagram of an embodiment of a combined rewards process (400) according to the invention. Existing or new credit card eligible for rewards is available to a customer (402). The customer enrolls in the combined rewards program through the branches, mail, and customer service, etc. (404). Wells Fargo (WF) systems identify eligible check cards that have the same SSN/Enterprise Customer Number (unique to WF) (406). The customer is formally enrolled in the rewards program with credit and check cards as products (408). The First Data Resources credit card system of record (FDR) sends a daily file to WF's enterprise system of record (410). FDR also sends a file to Plastic Issuance, a check card system of record, to flag the check cards (412). In addition, FDR sends a fulfillment kit, including a letter, brochure, terms and conditions, etc., to rewards program enrollees (414). FDR calculates points based on transactions (416). FDR sends a file to a rewards vendor, e.g. Maritz, with enrollment data and points earned (418). Points can be displayed on the Wells Fargo or vendor's web site, where the points are also available for redemption (420); the number of points earned per credit card and check card are detailed. All items that are redeemable are available via the Wells Fargo web site (420). FDR issues monthly credit card statement with points displayed; the number of points earned per credit card and check card are detailed (422). WF sends a quarterly rewards newsletter with points summary and where the number of points earned per credit card and check card are detailed (424).

An Example Relationship Rewards Implementation

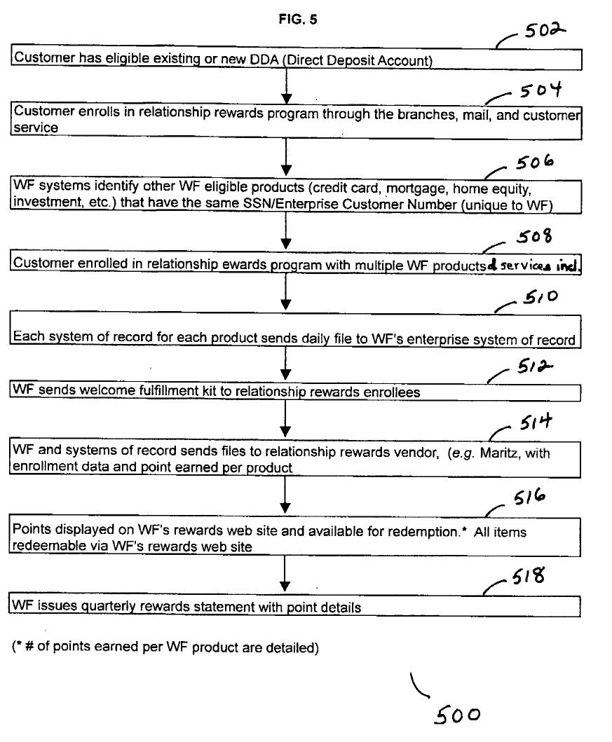

An example implementation by Wells Fargo can be described with reference to FIG. 5, a flow diagram of an embodiment of a relationship rewards process (500) according to the invention. A customer has an eligible existing or new Direct Deposit Account (DDA) (502). The customer enrolls in the relationship rewards program through the branches, mail, and customer service (504). Wells Fargo (WF) systems identify other WF eligible products, such as for example, credit card, mortgage, home equity, investment, etc., that have the same SSN/Enterprise customer number (unique to WF) (506). The customer gets enrolled in the relationship rewards with multiple WF products included (508). Each system of record for each product sends a daily file to the Wells Fargo enterprise system of record (510). Wells Fargo sends a welcome fulfillment kit to the relationship rewards enrollees (512). Wells Fargo sends files to a relationship rewards vendor, e.g. Maritz, with enrollment data and points earned per product (514). Points are displayed on the Wells Fargo web site and are available for redemption; the number of points earned per WF product are detailed (516). All items are redeemable via the Wells Fargo web site (516). Wells Fargo issues a quarterly relationship rewards statement with point details (518).

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. A computer-implemented system for a combined rewards program, the system comprising:
means for a customer making a request to enroll into a combined rewards program;
responsive to said request to enroll, means for identifying and additionally systematically enrolling into the program related items associated with the customer, said means for identifying and additionally automatically enrolling using a unique customer identifier;
responsive to said enrolling, means for performing fulfillment; and
means for sending reward recommendations and offers to the customer.

2. The computer-implemented system of claim 1, further comprising:
multiple system of records of card products for identifying and enrolling accounts, performing fulfillment, and sending reward recommendations and offers.

3. The computer-implemented system of claim 1, further comprising:
one or more entry points, wherein said one or more entry points are external or internal to an enterprise.

4. A computer-implemented relationship rewards process, comprising the steps of:
providing a one enrollment mechanism, whereby a customer enrolls into a relationship rewards program at one entry point and systematically has one or more eligible accounts enrolled into the relationship rewards program;
for each system of record for each enrolled account, sending a periodic file feed to an enterprise system of record for tracking;
said enterprise system of record using each said periodic file feed to track points earned per product and to combine said points into a total amount of points;
said enterprise system of record sending said points per product and said total amount of points to other systems for providing a points summary to a customer;
said enterprise system of record and any of said each system of record sending files with enrollment data and points earned per product to a relationship rewards vendor for the vendor's records; and
displaying and making available for redemption said total amount of points, wherein said total amount of points are also itemized.

5. The computer-implemented relationship rewards process of claim 4, further comprising:
responsive to said enrollment, said enterprise system of record sending a fulfillment kit to said customer for confirming enrollment and outlining benefits of the program.

6. The computer-implemented relationship rewards process of claim 4, wherein said displaying and making available for redemption is online, on a statement, and via a customer service representative.

7. The computer-implemented relationship rewards process of claim 4, wherein the enrollment request is made via any of online, branches, mail, and customer service.

8. The computer-implemented relationship rewards process of claim 4, further comprising the step of:
matching a primary and a secondary predetermined unique number of a cardholder for enrolling credit and check cards.

9. A computer-implemented combined cash back rewards process, comprising the steps of:
providing a one enrollment mechanism, whereby a customer enrolls into a combined cash back rewards program at one entry point and automatically has one or more accounts enrolled into the program;
for each system of record for each enrolled account, sending a periodic file feed to an enterprise system of record for tracking;
said enterprise system of record using each said periodic file feed to track cash back amount earned per product and to combine said cash back amount into a total cash back amount;
said enterprise system of record sending said cash back amount per product and said total cash back amount to other systems for providing a cash back amount summary to a customer; and
displaying and making available for redemption said total cash back amount, wherein said cash back amounts are shown itemized.

10. The computer-implemented cash back rewards process of claim 9, wherein a customer can request a cash rebate check or statement credit in fixed dollar increments.

11. The computer-implemented cash back rewards process of claim 9, further comprising:
responsive to said enrollment, said enterprise system of record sending a fulfillment kit to said customer for confirming enrollment and outlining benefits of the program.

12. The computer-implemented cash back rewards process of claim 9, wherein said displaying and making available for redemption is on a statement and via a customer service representative.

13. The computer-implemented cash back rewards process of claim 9, wherein the enrollment request is made via any of online, branches, mail, and customer service.

14. The computer-implemented cash back rewards process of claim 9, further comprising the step of:
matching a primary and a secondary predetermined unique number of a cardholder for enrolling credit and check cards.
